(19) United States
(12) Patent Application Publication
(10) Pub. No.: US 2025/0238660 A1
(43) Pub. Date: Jul. 24, 2025

(54) COMPUTING SYSTEM AND NON-TRANSITORY STORAGE MEDIUM INCLUDING ATTENTION-BASED ARTIFICIAL INTELLIGENCE MODEL

(71) Applicant: A123 Corporation, Wilmington, DE (US)

(72) Inventors: Byonghwa OH, Seoul (KR); Byungchul HONG, Ulsan (KR); Jihun OH, Gyeonggi-do (KR)

(73) Assignee: A123 Corporation, Wilmington, DE (US)

(21) Appl. No.: 18/428,262

(22) Filed: Jan. 31, 2024

(30) Foreign Application Priority Data
Jan. 19, 2024 (KR) 10-2024-0008803

(51) Int. Cl. G06N 3/047

(52) U.S. Cl. CPC G06N 3/047

(57) ABSTRACT

A computing system that performs a process using an attention-based artificial intelligence model includes: at least one processor configured to control a process using the artificial intelligence model; and a memory configured to store instructions performed by the at least one processor, wherein, when performing a process of an attention layer, the at least one processor is configured to: obtain a query feature map matrix and a key feature map matrix from an input sequence including a plurality of tokens; obtain an attention score matrix based on a dot-product of the obtained query feature map matrix and key feature map matrix; for each of attention score vectors of the plurality of tokens included in the obtained attention score matrix, set a threshold based on a maximum value from among included attention scores; and bypass a softmax operation for an attention score less than the set threshold for each of the attention score vectors of the plurality of tokens.

### CROSS-REFERENCE TO RELATED APPLICATIONS

This application claims the benefit of Korean Patent Application No. 10-2024-0008803, filed on Jan. 19, 2024, in the Korean Intellectual Property Office, the disclosure of which is incorporated herein in its entirety by reference.

### BACKGROUND

### 1. Field

The disclosure relates to a computing system and a non-transitory storage medium including an attention-based artificial intelligence model.

### 2. Description of the Related Art

A Large Language Model (LLM), widely known through the emergence of ChatGPT, is a general term for artificial intelligence trained to understand and generate human language. LLM may learn large-scale language data to understand sentence structure, grammar, meaning, and other meanings inherent in words, and generate language. In particular, LLM may accurately interpret the meaning of a sentence by identifying similarities and context formation between words.

Recently, as competition between companies for LLM has intensified, a parameter size of LLM is rapidly increasing, and it has reached a point where computing performance cannot smoothly support this increase. In particular, memory performance (speed or bandwidth) is not sufficiently improved compared to processor performance (computation speed), which may hinder the smooth use of LLM.

### SUMMARY

Provided are methods of maintaining performance while reducing a memory bandwidth and computational load of an attention layer in an attention-based artificial intelligence model such as a transformer.

According to an aspect of an embodiment, a computing system that performs a process using an attention-based artificial intelligence model comprises: at least one processor configured to control a process using the artificial intelligence model; and a memory configured to store instructions performed by the at least one processor, when performing a process of an attention layer included in the artificial intelligence model, the at least one processor is configured to: obtain a query feature map matrix and a key feature map matrix from an input sequence including a plurality of tokens; obtain an attention score matrix based on a dot-product of the obtained query feature map matrix and key feature map matrix; for each of attention score vectors of the plurality of tokens included in the obtained attention score matrix, set a threshold based on a maximum value from among included attention scores; and bypass a softmax operation for an attention score less than the set threshold for each of the attention score vectors of the plurality of tokens.

According to an exemplary embodiment, a threshold for a specific attention score vector from among the attention score vectors is set based on a maximum value from among attention scores included in the specific attention score vector and a certain parameter.

According to an exemplary embodiment, the threshold is set according to the equation below,

$$threshold = ln ( β ) + max ( {s}_{i} )$$

where β is the parameter, and max(sᵢ) is the maximum value from among the attention scores included in the specific attention score vector.

According to an exemplary embodiment, the parameter is set to have a value included in a range of 0.0005 to 0.002.

According to an exemplary embodiment, the at least one processor processes an attention score less than the threshold as 0 based on a threshold set for each of the attention score vectors.

According to an aspect of an embodiment, a computing system that performs a process using an attention-based artificial intelligence model comprises: at least one processor configured to control a process using the artificial intelligence model; and a memory configured to store instructions performed by the at least one processor, when performing a process of an attention layer included in the artificial intelligence model, the at least one processor is configured to: obtain a query feature map matrix, a key feature map matrix, and a value feature map matrix from an input sequence including a plurality of tokens; obtain an attention score matrix based on a dot-product of the obtained query feature map matrix and key feature map matrix; obtain an attention probability matrix through a softmax operation on the obtained attention score matrix; set a threshold based on a length of the corresponding input sequence, for each attention probability vector in the attention probability matrix; and bypass a dot-product with the value feature map matrix for elements of the attention probability vector less than the set threshold from among respective attention probabilities of the plurality of tokens included in the attention probability matrix.

According to an exemplary embodiment, the threshold is set based on the length of the input sequence and a certain parameter.

According to an exemplary embodiment, the threshold is set according to the equation below,

$$threshold = \frac{α}{seq\_len}$$

where α is the parameter, and seq_len is the length of the input sequence.

According to an exemplary embodiment, the parameter is set to have a value included in a range of 0.2 to 0.6.

According to an exemplary embodiment, the at least one processor processes a value of an attention probability less than the threshold from among the respective attention probabilities of the plurality of tokens as 0.

According to an aspect of an embodiment, a non-transitory computer-readable storage medium having recorded thereon instructions for executing an attention-based artificial intelligence model, wherein a processor of the computer is configured to execute the instructions to: obtain a query feature map matrix and a key feature map matrix from an input sequence including a plurality of tokens; obtain an attention score matrix based on a dot-product of the obtained query feature map matrix and the key feature map matrix; for each of attention score vectors of the plurality of tokens included in the obtained attention score matrix, set a threshold based on a maximum value from among included attention scores; and perform thresholding on an attention score less than a set threshold for each of the attention score vectors of the plurality of tokens.

### BRIEF DESCRIPTION OF THE DRAWINGS

Embodiments of the disclosure will be more clearly understood from the following detailed description taken in conjunction with the accompanying drawings in which:

FIG. 1 is a functional block diagram of a transformer as an example of a model to which an attention mechanism is applied, according to an embodiment;

FIG. 2 is a view of a configuration of an attention layer according to an embodiment;

FIG. 3 is an exemplary view for explaining an operation performed through the attention layer according to the embodiment of FIG. 2;

FIG. 4 is a view of data showing performance changes according to sparsity of an attention-based artificial intelligence model according to the embodiment of FIG. 2;

FIG. 5 is a view of a configuration of an attention layer according to an embodiment;

FIG. 6 is an exemplary view for explaining an operation performed through the attention layer according to the embodiment of FIG. 5;

FIG. 7 is a view of data showing performance changes according to sparsity of an attention-based artificial intelligence model according to the embodiment of FIG. 5; and

FIG. 8 is a schematic block diagram of a computing system in which an attention-based artificial intelligence model is executed, according to embodiments.

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the disclosure will be thorough and complete, and will fully convey the scope of the inventive concept to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

The terms “unit”, “device”, “˜er (˜or)”, “module”, etc., refer to a processing unit of at least one function or operation, which may be implemented by hardware such as a processor, a microprocessor, an application processor, a micro controller, a central processing unit (CPU), a graphics processing unit (GPU), an accelerate processor unit (APU), a digital signal processor (DSP), an application specific integrated circuit (ASIC), a field programmable gate array (FPGA), a neural processing unit (NPU), a neuromorphic processor, etc., software, or a combination of hardware and software, and may be implemented in a form combined with a memory that stores data necessary for processing at least one function or operation.

Throughout the specification, components may be discriminated by their major functions. For example, two or more components as herein used may be combined into one, or a single component may be subdivided into two or more sub-components according to subdivided functions. Each of the components may perform its major function and further perform part or all of a function served by another component. In this way, part of a major function served by each component may be dedicated and performed by another component.

As used herein, the term “and/or” includes any and all combinations of one or more of the associated listed items.

Hereinafter, embodiments of the inventive concept will be described in detail with reference to the accompanying drawings.

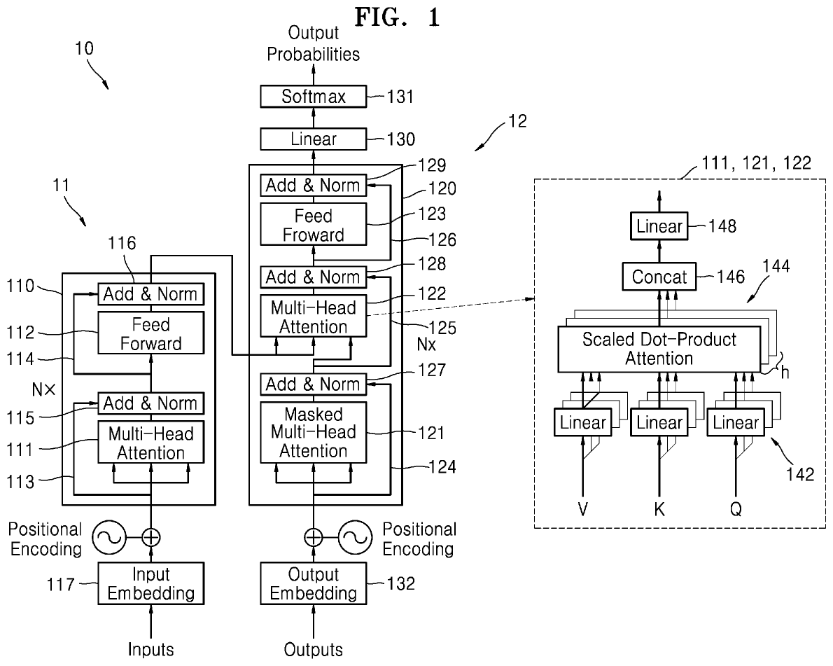

FIG. 1 is a functional block diagram of a transformer as an example of a model to which an attention mechanism is applied, according to an embodiment.

The attention mechanism emerged to solve information loss and vanishing gradient problems of the conventional seq2seq model, and uses a method of referring back to an entire input sentence from an encoder at each output time of a decoder. In particular, the attention mechanism is implemented not to refer to the entire input sentence of the encoder at the same rate, but to pay attention (assign weight) to a part of an input word that is related to a word to be predicted at that point in time.

For convenience of explanation, FIG. 1 shows a transformer 10 as an example of an artificial intelligence model to which the attention mechanism described above is applied, but a model to which the attention mechanism according to embodiments described later is applied is not limited to the transformer 10.

The configuration of the transformer 10 shown in FIG. 1 may be substantially the same or similar to the configuration of the model disclosed in the “Attention Is All You Need” (Vaswani et al.) paper published in June 2017, excluding multi-head attention sublayers 111, 121, and 122.

Based on this, referring to FIG. 1, the transformer 10 may provide output data by performing inference on given input data (input sequence). The transformer 10 may include a plurality of encoders 11 and a plurality of decoders 12. Each of the encoders 11 and/or decoders 12 may be implemented in a form in which N identical layers 110 and 120 are repeated (N is a natural number greater than or equal to 2).

Each of the layers 110 of the encoder 11 may include a multi-head attention submodel 111 and a feed forward submodel 112, where each submodel may also be referred to as a sublayer. Residual connection 113 and 114 and layer normalization 115 and 116 may be applied to each of the sublayers 111 and 112.

Each token (e.g., word) included in an input to the encoder 11 is converted into an embedding vector by an embedding 117, and a positional encoding value representing position information of each token is added to the embedding vector to be used as an input to the transformer 10. The input may be input to a first encoder from among the plurality of encoders 11. The encoders 11 may sequentially perform operations corresponding to the number of layers 110 and then provide an output value of the last encoder to the decoders 12.

Each of the layers 120 of the decoders 12 may include a masked multi-head attention sublayer 121, a multi-head attention sublayer 122, and a feed forward sublayer 123. Similar to the encoders 11, residual concatenation 124, 125, and 126 and layer normalization 127, 128, and 129 may be applied to the sublayers 121, 122, 123, respectively.

A first decoder from among the decoders 12 may receive an embedding vector (to which a positional encoding value is added) of a previous output sequence derived by embedding 132. The decoders 12 sequentially perform operations corresponding to the number of layers 120, wherein an output value of the last decoder may be linearly transformed through a linear process 130, and a result of applying a softmax function 131 to a linearly transformed value may be provided as an output sequence.

In a training process of the transformer 10, the entire output sequence is input to the decoders 12 at once, so a phenomenon may occur in which even a future token may be referenced when predicting a current token. To prevent this, each of the layers 120 of the decoders 12 may include the masked multi-head attention sublayer 121.

The multi-head attention sublayers 111, 121, and 122 included in the transformer 1 will be described in more detail. The multi-head attention sublayers 111, 121, and 122 of the transformer 1 may include h (h is a natural number) linear projection layers 142, h scaled dot-product attention layers 144, a concatenation layer 146, and a linear projection layer 148 for matrices (vectors) Q, K, and V, respectively. The multi-head attention sublayers 111, 121, and 122 may be implemented as a self-attention model, but are not limited thereto.

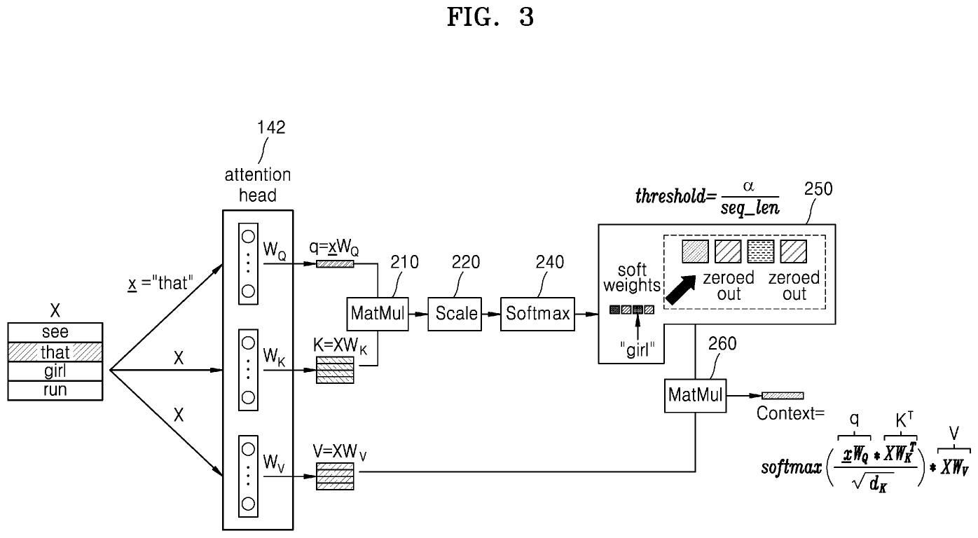

The scaled dot-product attention layer 144 (hereinafter abbreviated as ‘attention layer’) of each of the multi-head attention sublayers 111, 121, and 122 may receive linear projections of Q, K, and V and perform a certain operation process. Q may correspond to a matrix containing a query (vector representation of one token (one word) in a sequence), K may correspond to a matrix of all keys (vector representations of all tokens (all words) in a sequence), and V may correspond to a matrix of all values (vector representations of all tokens (all words) in a sequence). At this time, weight matrices W_{Q}, W_{K}, and W_{V} (see FIG. 3) that are multiplied by the matrices Q, K, and V, respectively, during linear projection of the linear projection layer 142 may be defined (or trained) differently for each head. Accordingly, the multi-head attention sublayers 111, 121, and 122 capture various features from an input sequence (sentence), thereby enabling the transformer 10 to understand various features or patterns within the sequence.

The attention layer 144 may perform various operations (matrix product, softmax, etc.) on linear projections of the matrices Q, K, and V to identify context for an input sequence, extract information, and generate an output. In this process, in the conventional form in which operations are made on all elements of each matrix, there is a problem that a bandwidth and capacity of a memory used during operation are large, and especially in a case of large-sized models such as LLM, smooth performance is not achieved due to bottlenecks.

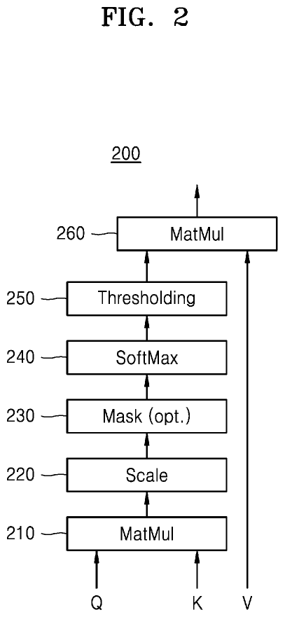

The attention layer 144 according to embodiments to solve the problems described above will be described in more detail later with reference to FIGS. 2 to 7.

The concatenation layer 146 may concatenate output values from respective heads of the scaled dot-product attention layer 144, and the linear projection layer 148 may reflect a weight matrix on the concatenated output values to perform linear projection.

The feed forward sublayers 112 and 123 may include a fully-connected feed forward neural network that is independently applied to each position. The feed forward sublayers 112 and 123 may capture various features at each position and adjust representation in a multidimensional space by transforming and augmenting information about each position.

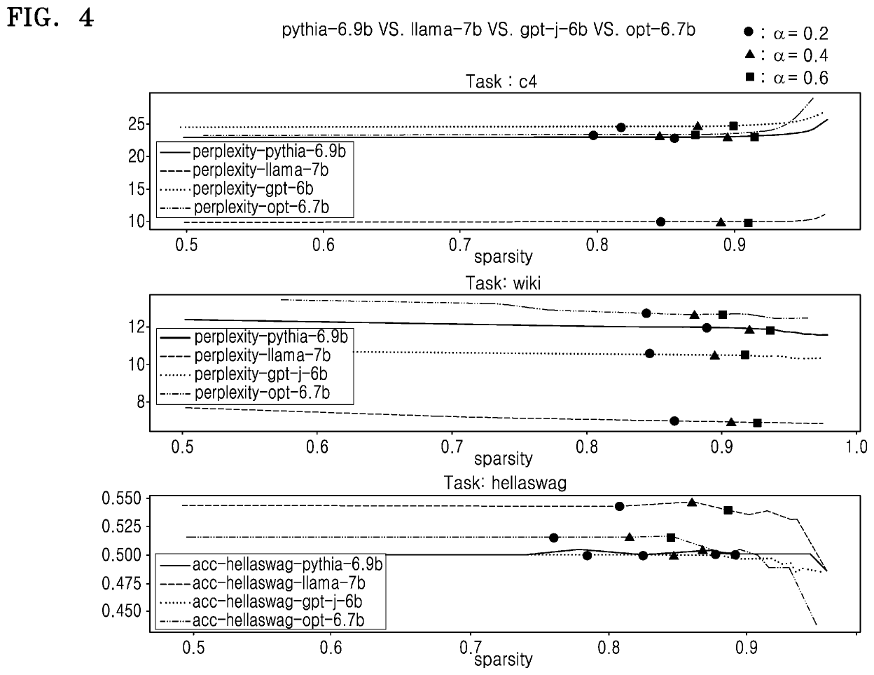

FIG. 2 is a view of a configuration of an attention layer according to an embodiment. FIG. 3 is an exemplary view for explaining an inference process using the attention layer according to the embodiment of FIG. 2. FIG. 4 is a view of data showing performance changes according to sparsity of an attention-based artificial intelligence model according to the embodiment of FIG. 2.

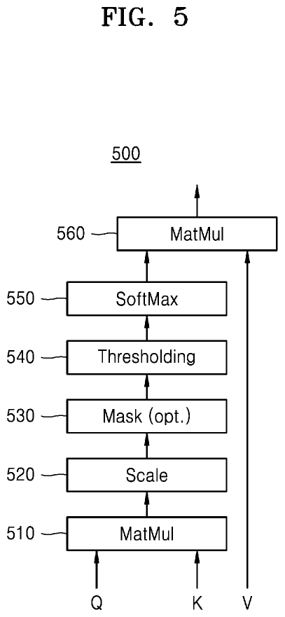

Embodiments described herein may be implemented as software, hardware, or a combination of these to reduce memory usage and computational load of an attention layer 200 or 500 (see FIG. 5), and may be applied to a graphic processing unit (GPU), an accelerator for machine learning, or a neuromorphic semiconductor, etc.

Referring to FIGS. 2 and 3, the attention layer 200 may refer to the scaled dot-product attention layer 144 corresponding to a head of any one of the multi-head attention sublayers 111, 121, and 122 described above in FIG. 1.

According to an embodiment, the attention layer 200 may include scaled dot-product blocks 210 and 220, a mask block 230, a softmax block 240, a thresholding block 250, and a dot-product block 260. Among these, the mask block 230 may not be included in the attention layer 200. For example, the mask block 230 may be included in an attention layer of the masked multi-head attention sublayer 121 and may apply masking to a token (word) at a future time to prevent reference to the token at the future time.

Hereinafter, in this specification, a computing system including a processor and memory is described as performing inference or learning using an attention layer and the transformer 10.

The computing system may add position information (positional encoding, see FIG. 1) to an embedding vector of each token (word) included in an input sequence, and obtain a query vector, key matrix, and value matrix based on the embedding vector of each token to which the position information has been added. The query vector may correspond to an embedding vector x of a token corresponding to a specific point in time, and the key matrix and value matrix may correspond to an embedding matrix X including embedding vectors of all tokens included in the input sequence.

The computing system may obtain a query feature map matrix Q, a key feature map matrix K, and a value feature map matrix V by multiplying embedding vectors of input tokens by the linear projection weight matrices W_{Q}, W_{K}, and W_{V}, respectively. As described above, the weight matrices W_{Q}, W_{K}, and W_{V} may have different values for each head.

The computing system may obtain an attention score matrix through the scaled dot-product 210 and 220 between the query feature map matrix (and a vector q constituting the same) and the key feature map matrix K. The attention score matrix may include respective attention score vectors for query feature map vectors (tokens), and each of the attention score vectors may include multiple attention scores. In addition, each of the attention scores may correspond to an attention score on which the scaling 220 has been performed. At this time, to perform the dot-product operation between matrices, a transpose matrix K^{T} of the key feature map matrix K may be used. An attention score vector (qK^{T}/\sqrt{dₖ}, dₖ is the number of dimensions of a key vector) refers to the similarity between a specific query feature map vector and key feature map vectors (matrices). The higher the value in an attention score, the higher the similarity between a query feature map vector and corresponding key feature map matrices (vectors). The computing system may obtain an attention probability vector by applying the softmax 240 to the obtained attention score vector, the attention probability vector may include attention probabilities obtained by normalizing a plurality of attention scores included in the attention score vector. The attention probability may represent a probability value for each token (word) in a sequence.

In the conventional case, the computing system may calculate a weighted sum of each position by performing the dot-product 260 between an obtained attention probability vector and value feature map matrices (vectors). In this case, as the dot-product is performed between all elements (attention probabilities) included in the attention probability vector and the value feature map matrices, a load due to memory usage, number of reads/writes, and number of computations may occur. However, in a case of an attention probability to which the softmax function 240 is applied, probability values of tokens with a relatively high attention score further increase, and probability values of tokens with a relatively low attention score further decrease. In this case, tokens with a low attention probability may not have a significant impact on an inference result.

Based on this, according to an embodiment, the computing system may perform the thresholding 250 on an attention probability vector, thereby processing elements with probability values less than a threshold as 0 (e.g., replacing the elements with 0). In this case, by not performing (bypassing) the dot-product on the elements processed as 0, a memory bandwidth and computational load may be minimized.

According to an embodiment, the threshold may be variably set according to a length of an input sequence (sentence) currently being processed, as shown in Equation 1 below.

$$threshold = \frac{α}{seq\_len} \qquad [ Equation 1 ]$$

Where α is a user-specifiable parameter, and seq_len means a length of an input sequence. Therefore, in the above equation, the longer the length of the input sequence, the smaller the threshold may be set. The reason is that the total attention probability is 1, but the longer the sequence, the smaller the size of all values of each element (i.e., they are inversely proportional). As the threshold increases, elements of the attention probability vector that are processed as 0 increase, so required memory bandwidth and computational load may be reduced, but inference accuracy may also be reduced. Accordingly, setting appropriate parameters may be necessary to effectively reduce a memory bandwidth and computational load while ensuring an appropriate inference performance.

Referring to FIG. 4 in relation to the settings of the above parameters, graphs in FIG. 4 show sparsity, perplexity, and accuracy measured while changing the parameters for various language models (Pythia, LLAMA, GPT, and OPT) and data sets (c4, wiki, and hellaswag) constructed including an attention layer or a transformer.

To briefly explain each measure, sparsity is a measure related to the proportion of elements with a value of 0 from among the model parameters (e.g., attention probability values). The larger the sparsity value, the higher the ratio of parameters with a value of 0. The problem of high memory bandwidth and computational load described above may be solved as the sparsity measure increases. This is because a parameter with a value of 0 remains 0 no matter what value it is multiplied by, so for a value of 0, access to a memory area where values to be multiplied are stored is not required. In other words, as sparsity increases, a memory bandwidth and computational load may be reduced. Perplexity is a measure that evaluates how accurately a language model makes predictions with low uncertainty. In general, a lower perplexity value indicates that a language model may predict the next word with a higher probability. Accuracy is a measure of the proportion of correct predictions of a model.

Referring to an example graph in FIG. 4, it can be seen that when the parameter α ranges from 0.2 to 0.6, the sparsity of each model increases while performance is maintained above a certain level. In addition, it can be seen that when the parameter α ranges from 0.2 to 0.4, there is almost no performance degradation in each model. Based on this, the parameter α that determines a threshold according to an embodiment may exemplarily be set in the range of 0.2 to 0.6, and in terms of minimizing performance degradation, it may be desirable to set it in the range of 0.2 to 0.4. In the embodiment described above, it is exemplified that the parameter α may be set in the range of 0.2 to 0.6, but this is an appropriate value suggested for general transformer-based language models. In addition, a setting range of the parameter α may be changed for other transformer-based language models that exist or will be released in the future.

According to an embodiment, a threshold for thresholding an attention probability is set based on a length of an input sequence and an appropriate parameter, thereby maximizing processing efficiency of an attention layer for input sequences of various lengths.

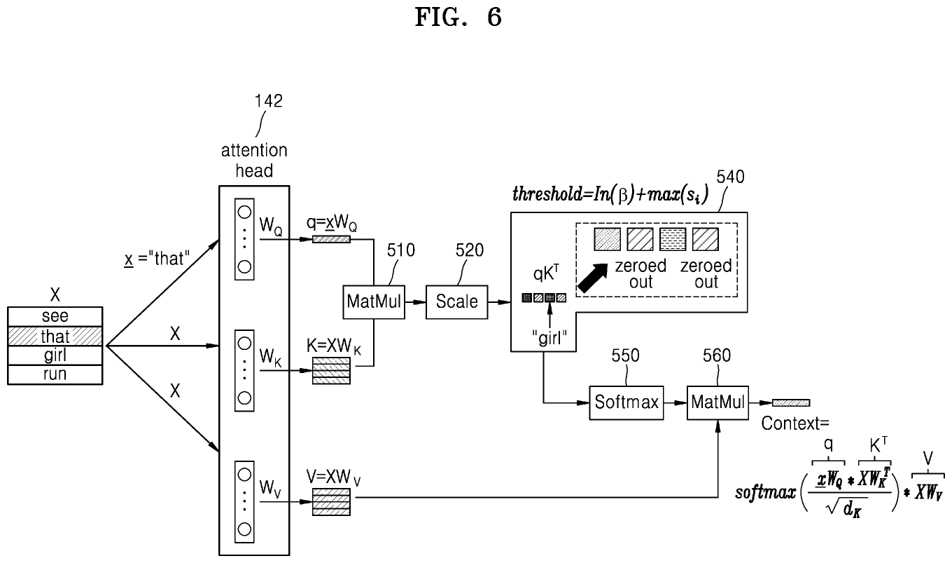

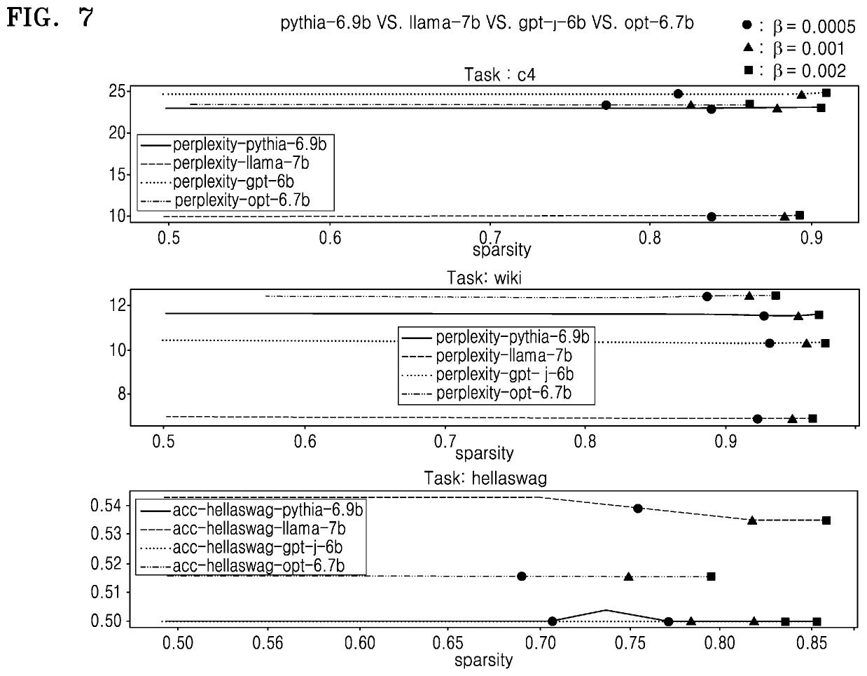

FIG. 5 is a view of a configuration of an attention layer according to an embodiment. FIG. 6 is an exemplary view for explaining an inference process using the attention layer according to the embodiment of FIG. 5. FIG. 7 is a view of data showing performance changes according to sparsity of an attention-based artificial intelligence model according to the embodiment of FIG. 5.

Referring to FIG. 5, like the attention layer 200 of FIG. 2, the attention layer 500 may refer to the scaled dot-product attention layer 144 corresponding to a head of any one of the multi-head attention sublayers 111, 121, and 122 described above in FIG. 1.

According to an embodiment, the attention layer 500 may include scaled dot-product blocks 510 and 520, a mask block 530, a thresholding block 540, a softmax block 550, and a dot-product block 560. The scaled dot-product blocks 510 and 520, mask block 530, softmax block 550, and dot-product block 560 are substantially the same as or similar to the configurations described above in FIG. 2, so duplicate descriptions thereof will not be given herein.

In FIG. 5, the thresholding block 540 is shown as being placed immediately before the softmax block 550, but according to an embodiment, the thresholding block 540 may be between the dot-product block 510 and the scaling block 520 of the scaled dot-product blocks 510 and 520 or between the scaling block 520 and the mask block 530. When the thresholding block 540 is between the dot-product block 510 and the scaling block 520, a threshold (Equation 2), which will be described later, may be modified. As a result, the thresholding block 540 may be placed before the softmax block 550.

Based on this, referring to FIG. 6, the computing system may add position information (positional encoding, see FIG. 1) to an embedding vector of each token (word) included in an input sequence, and obtain a query vector, key matrix, and value matrix based on the embedding vector of each token to which the position information has been added. The query vector may correspond to the embedding vector x of a token corresponding to a specific point in time, and the key matrix and value matrix may correspond to the embedding matrix X including embedding vectors of all tokens included in the input sequence.

The computing system may obtain the query feature map matrix Q, the key feature map matrix K, and the value feature map matrix V by multiplying embedding vectors of input tokens by the linear projection weight matrices W_{Q}, W_{K}, and W_{V}, respectively. As described above, the weight matrices W_{Q}, W_{K}, and W_{V} may have different values for each head.

The computing system may obtain an attention score matrix through the scaled dot-product 510 and 520 between the query feature map matrix (the vector q constituting the same) and the key feature map matrix K. The attention score matrix may include respective attention score vectors for query feature map vectors (tokens), and each of the attention score vectors may include multiple attention scores. In addition, each of the attention scores may correspond to an attention score on which the scaling 520 has been performed. At this time, to perform the dot-product between matrices, the transpose matrix K^{T} of the key feature map matrix K may be used. The attention score vector (qK^{T}/\sqrt{dₖ}, dₖ is the number of dimensions of a key vector) refers to the similarity between a specific query feature map vector and key feature map vectors (matrices). The higher the value in an attention score, the higher the similarity between a query feature map vector and corresponding key feature map matrices (vectors).

In the conventional case, the computing system may obtain an attention probability vector by performing the scaling 520 and the softmax 550 on the obtained attention score vector. At this time, because the softmax operation has a relatively high load compared to other operations, it may occupy the largest portion of the total load of the attention layer 500. In addition, each of attention probabilities included in the attention probability vector becomes higher as an attention score before softmax 550 is higher, and becomes lower as the attention score is lower. Therefore, a relative magnitude relationship of values does not change after calculating the attention probabilities. Therefore, by performing the thresholding 540 before the softmax 550, the computing system according to the embodiment may reduce a memory bandwidth and computational load caused by the softmax 550 and improve the efficiency of the attention layer 500.

In more detail, the computing system may perform the thresholding 540 on an attention score matrix and process elements less than a threshold from among elements (attention scores) included in the attention score matrix as 0. In this case, because the elements of the attention score matrix that are processed as 0 are bypassed and the softmax 550 is performed only on the remaining elements, a memory bandwidth and computational load may be minimized. In addition, for the bypassed elements with the value of 0, the dot-product operation is not performed (is bypassed) in the dot-product block 560 like the dot-product block 260 of FIG. 2, thereby further reducing the memory bandwidth and computational load.

According to an embodiment, the threshold may be variably set based on a maximum value from among attention scores included in each of attention score vectors of tokens, as shown in Equation 2 below.

$$threshold = ln ( β ) + max ( {s}_{i} ) \qquad [ Equation 2 ]$$

Where β may be a parameter that can be specified by a user, ln(β) may be a natural logarithm of β, and max(sᵢ) may be a maximum value from among attention scores of an attention score vector corresponding to a specific input sequence. That is, the above equation corrects the maximum value from among the attention scores to ln(β). This reflects the fact that the maximum value in the softmax operation has a great influence on attention probability calculation. As the threshold increases, the number of elements of the attention score matrix that are processed as 0 increases, so a memory bandwidth and computation load may decrease, but inference accuracy may also decrease. Accordingly, setting an appropriate value of the parameter β may be necessary to effectively reduce a memory bandwidth and computational load while ensuring an appropriate inference performance.

Referring to FIG. 7 in relation to the settings of the above parameters, graphs in FIG. 7 show sparsity, perplexity, and accuracy measured while changing the parameters for various language models (Pythia, LLAMA, GPT, and OPT) and data sets (c4, wiki, and hellaswag) constructed including an attention layer or a transformer.

In the example graphs of FIG. 7, it can be seen that when a parameter β ranges from 0.0005 to 0.002, the sparsity of each model increases (about 70% or more) while performance is maintained above a certain level. In addition, it can be seen that when the parameter β ranges from 0.0005 to 0.001, there is almost no performance degradation in each model. Based on this, the parameter β that determines a threshold according to an embodiment may exemplarily be set in the range of 0.0005 to 0.002, and in terms of minimizing performance degradation, it may be desirable to set it in the range of 0.0005 to 0.001. In the embodiment described above, it is exemplified that the parameter β may be set in the range of 0.0005 to 0.002, but this is an appropriate value suggested for general transformer-based language models. In addition, a setting range of the parameter β may be changed for other transformer-based language models that exist or will be released in the future.

According to an embodiment, by setting a threshold for thresholding an attention score for each token based on a maximum value from among attention scores and an appropriate parameter, a load on an attention layer by a softmax operation and a dot-product operation with a subsequent value feature map matrix may be effectively reduced while maintaining inference performance. In addition, in another example, instead of calculating the maximum value from among the attention scores for each attention score vector, a result of statistically calculating a maximum value on some example (sample) data before implementation may instead be used. In this case, a calculation load may be further reduced because a threshold may be set by retrieving an existing value instead of calculating a maximum value.

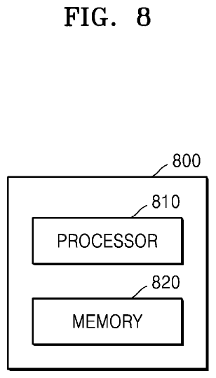

FIG. 8 is a schematic block diagram of a computing system in which an attention-based artificial intelligence model is executed, according to embodiments.

Referring to FIG. 8, a computing system 800 according to an embodiment may include a processor 810 and memory 820. However, components of the computing system 800 are not limited to the examples described above. For example, the computing system 800 may further include additional components in addition to the components described above, such as a network interface and an input/output interface. The computing system 800 may include various computing devices such as mobile terminals (smart phones, etc.), PCs, and servers.

There may be at least one processor 810, and there may be at least one memory 820. In addition, two or more of the processor 810 and the memory 820 may be combined into one chip.

The processor 810 may control all operations of the computing system 800 and may perform inference or learning using the attention layer 200 or 500 described above and the transformer 10 including the same. In particular, the processor 810 may process the processes of the attention layer 200 or 500 described above in FIGS. 2 and 3 and FIGS. 5 and 6.

The processor 810 may include hardware such as a central processing unit (CPU), an application processor (AP), an integrated circuit, a microcomputer, an application specific integrated circuit (ASIC), a field programmable gate array (FPGA), a graphic processing unit (GPU), and/or a neural processing unit (NPU).

According to an embodiment, the memory 820 may store programs and data necessary for the operations of the computing system 800. For example, the memory 820 may store instructions performed by the processor 810 and may store at least one of data generated or obtained through the processor 810. In addition, the memory 820 may store data related to the attention layer 200 or 500 described above and the transformer 10 including the same.

The memory 820 may be composed of a storage medium such as ROM, RAM, flash memory, SSD, or HDD, or a combination of storage media.

According to the inventive concept, by bypassing a softmax operation or a dot-product operation by processing an attention score or attention probability value corresponding to a value less than a threshold set for each of attention score vectors or attention probability vectors of a plurality of tokens as 0, a memory bandwidth and computational load required for each operation may be effectively reduced. Accordingly, utility may be increased by improving problems such as memory bottlenecks that occur in large language models such as LLM.

In addition, according to the inventive concept, by appropriately setting a threshold for thresholding, the efficiency of an artificial intelligence model may be maximized by reducing a memory bandwidth and computational load of the artificial intelligence model including an attention layer while maintaining performance.

In addition, by adaptively setting the threshold based on a length of an input sequence or a maximum value of an attention score, the burden of separate re-learning or fine-tuning to search for an optimal value of the threshold may be eliminated.

Effects obtainable by the inventive concept are not limited to the effects described above, and other effects not described herein may be clearly understood by one of ordinary skill in the art to which the disclosure belongs from the above description.

While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the disclosure.

What is claimed is:

1. A computing system that performs a process using an attention-based artificial intelligence model, the computing system comprising:
at least one processor configured to control a process using the artificial intelligence model; and
a memory configured to store instructions performed by the at least one processor,
wherein, when performing a process of an attention layer included in the artificial intelligence model, the at least one processor is configured to:
obtain a query feature map matrix and a key feature map matrix from an input sequence including a plurality of tokens;
obtain an attention score matrix based on a dot-product of the obtained query feature map matrix and key feature map matrix;
for each of attention score vectors of the plurality of tokens included in the obtained attention score matrix, set a threshold based on a maximum value from among included attention scores; and
bypass a softmax operation for an attention score less than the set threshold for each of the attention score vectors of the plurality of tokens.

2. The computing system of claim 1, wherein a threshold for a specific attention score vector from among the attention score vectors is set based on a maximum value from among attention scores included in the specific attention score vector and a certain parameter.

3. The computing system of claim 2, wherein the threshold is set according to the equation below,
$$threshold = ln ( β ) + max ( {s}_{i} )$$
where β is the parameter, and max(sᵢ) is the maximum value from among the attention scores included in the specific attention score vector.

4. The computing system of claim 3, wherein the parameter is set to have a value included in a range of 0.0005 to 0.002.

5. The computing system of claim 1, wherein the at least one processor processes an attention score less than the threshold as 0 based on a threshold set for each of the attention score vectors.

6. A computing system that performs a process using an attention-based artificial intelligence model, the computing system comprising:
at least one processor configured to control a process using the artificial intelligence model; and
a memory configured to store instructions performed by the at least one processor,
wherein, when performing a process of an attention layer included in the artificial intelligence model, the at least one processor is configured to:
obtain a query feature map matrix, a key feature map matrix, and a value feature map matrix from an input sequence including a plurality of tokens;
obtain an attention score matrix based on a dot-product of the obtained query feature map matrix and key feature map matrix;
obtain an attention probability matrix through a softmax operation on the obtained attention score matrix;
set a threshold based on a length of the input sequence, for each attention probability vector in the attention probability matrix; and
bypass a dot-product with the value feature map matrix for elements of the attention probability vector less than the set threshold from among respective attention probabilities of the plurality of tokens included in the attention probability matrix.

7. The computing system of claim 6, wherein the threshold is set based on the length of the input sequence and a certain parameter.

8. The computing system of claim 7, wherein the threshold is set according to the equation below,
$$threshold = \frac{α}{seq\_len}$$
where α is the parameter, and seq_len is the length of the input sequence.

9. The computing system of claim 8, wherein the parameter is set to have a value included in a range of 0.2 to 0.6.

10. The computing system of claim 6, wherein the at least one processor processes a value of an attention probability less than the threshold from among the respective attention probabilities of the plurality of tokens as 0.

11. A non-transitory computer-readable storage medium having recorded thereon instructions for executing an attention-based artificial intelligence model, wherein a processor of the computer is configured to execute the instructions to:
obtain a query feature map matrix and a key feature map matrix from an input sequence including a plurality of tokens;
obtain an attention score matrix based on a dot-product of the obtained query feature map matrix and the key feature map matrix;
for each of attention score vectors of the plurality of tokens included in the obtained attention score matrix, set a threshold based on a maximum value from among included attention scores; and
perform thresholding on an attention score less than a set threshold for each of the attention score vectors of the plurality of tokens.

12. The non-transitory computer-readable storage medium of claim 11, wherein a threshold for a specific attention score vector among the attention score vectors is set based on a maximum value from among attention scores included in the specific attention score vector and a certain parameter.

13. The non-transitory computer-readable storage medium of claim 12, wherein the threshold is set according to the equation below,
$$threshold = ln ( β ) + max ( {s}_{i} )$$
where β is the parameter, and max(sᵢ) is the maximum value from among the attention scores included in the specific attention score vector.

14. The non-transitory computer-readable storage medium of claim 13, wherein the parameter is set to have a value included in a range of 0.0005 to 0.002.

15. The non-transitory computer-readable storage medium of claim 11, wherein the performing of thresholding comprises:
processing an attention score less than the threshold as 0 based on a threshold set for each of the attention score vectors of the plurality of tokens.
